(19) United States
(12) Patent Application Publication
(10) Pub. No.: US 2009/0078241 A1
(43) Pub. Date: Mar. 26, 2009

(54) METHOD FOR ADJUSTING A DISPLACEMENT PUMP THAT HAS A VARIABLE VOLUME FLOW RATE IN AN INTERNAL COMBUSTION ENGINE

(75) Inventors: Willi Schneider, Bodelshausen (DE); Torsten Helle, Tuebingen (DE)

Correspondence Address: Brinks Hofer Gilson & Lione/Ann Arbor, 524 South Main Street, Suite 200, Ann Arbor, MI, 48104, US

(73) Assignee: Joma-Hydromechanic GmbH, Bodelshausen (DE)

(21) Appl. No.: 12/323,375

(22) Filed: Nov. 25, 2008

Related U.S. Application Data
(63) Continuation of application No. PCT/EP2007/003236, filed on Apr. 12, 2007.

(30) Foreign Application Priority Data
Jul. 10, 2006 (DE) 10 2006 033 169.9

(51) Int. Cl. F02D 41/00; F04B 49/00

(52) U.S. Cl. 123/672; 417/1; 417/212

(57) ABSTRACT

The invention relates to a method for adjusting a displacement pump that has a variable volume flow rate in an internal combustion engine. Said method comprises the following steps: the displacement pump is driven; the fluid is conveyed to the consumption points in the internal combustion engine; at least one characteristic value is determined from the exhaust gas flow of the internal combustion engine; said characteristic value is forwarded to a control device as an actual value signal; the actual value signal is compared to a given target value; a control signal is preprocessed from the deviation between the actual value signal and the target value; the control signal is fed to an actuator; the volume flow rate of the displacement pump is modified by means of the actuator in accordance with the control signal; the steps of the method are repeated until the actual value signal is identical to the target value.

### CROSS-REFERENCE TO RELATED APPLICATIONS

This application is a continuation of International Application No. PCT/EP2007/003236 filed on Apr. 12, 2007, which claims the benefit of DE 10 2006 033 169.9, filed Jul. 10, 2006. The disclosures of the above applications are incorporated herein by reference.

### FIELD

The disclosure relates to a method of adjusting a displacement pump that has a variable volume flow rate in an internal combustion engine.

### BACKGROUND

The statements in this section merely provide background information related to the present disclosure and may not constitute prior art.

These types of displacement pumps are mainly used as lubricant pumps for oil lubrication in internal combustion engines. It is known that the adjustment of such pumps is done either mechanically, hydraulically, or mechanically hydraulically. The adjustment of a displacement pump with a variable volume flow rate is understood as the reduction or enlargement of its displacement chamber. In order to do this in the case of a vane-cell pump, the offset of the rotating rotor is changed in relation to the middle of the pump in such a way that the individual displacement chambers located between the vanes are enlarged or reduced in size. Modifying the offset is called adjustment. A pump is adjusted either when the installation pressure is supposed to be varied or the delivery volume has to be adjusted.

A displacement pump with variable volume is known from EP 1 387 906 A1. A characteristic value of the internal combustion engine is determined, in order to adjust the pump. This leads to very good results in lubricant pumps. If air charger pumps are used, however, no optimal results are achieved with regard to combustion, because with changing environmental conditions (air pressure, air temperature, etc.) the requested characteristic values do not necessarily change. So the conveyed volume of the pump, despite changing environmental conditions, is often not modified.

### SUMMARY

The present disclosure is inventively achieved with a method that features the characteristics of claim 1.

With this inventive method, a distinctive characteristic value from the exhaust gas flow of the internal combustion engine is determined and adjusted according to the deviation of this characteristic value from an actual value of the displacement pump until the characteristic value is identical to the target value.

In one form, a signal from a lambda probe in the exhaust gas flow is used as the characteristic value. In addition, the suction pressure (P_{S}), the supply pressure (P_{L}), the rotational speed (n) of the internal combustion engine and/or the displacement pump, the temperature (T) of the fluid and/or the delivery volume (Q) of the fluid are determined. This means, that there is also a possibility that several different characteristic values are determined, and that the displacement pump is controlled in accordance with this plurality or characteristic values. The plurality of characteristic values can be retrieved simultaneously or consecutively. In every case, however, the characteristic values from the exhaust gas flow are used.

Furthermore, the target value can be presented in the form of target value ranges, so that only a deviation of a certain order of magnitude will lead to an adjustment of the displacement pump. This can be adjusted in such a way, that, for example, a deviation of about 5% from the target value leads to an adjustment of the displacement pump, whereas deviations below this threshold value remain unremarkable.

Another variation provides for a modification of the flow volume only when the control signal changes by a predetermined amount. This could also be about 5% or about 10%.

The existing engine control computer, in which a plurality of characteristic data is already processed, can advantageously be used as a control device. The engine control computer is supplied with the data for the displacement pump, as well as the computation rules for the actual value/target-value comparison and for signal production. In that way, neither additional sensors nor additional wiring are required, so that the number of components needed is relatively small.

An electromotive or hydraulic drive is used as an actuator in one form of the present disclosure. The hydraulic drive can be acted on by a fluid in both directions of adjustment. The lubricant oil of the internal combustion engine can preferably be used as the fluid. When activating the actuator, the delivery volume of the displacement pump can be linearly, progressively, or degressively modified. This enlarges or diminishes the delivery volume of the displacement pump. This has the essential advantage that rapid modifications can be made in both directions.

The displacement pump can advantageously be a gas pump, particularly a charger, and in other forms is a hydrostatic or hydrodynamic charger.

Further areas of applicability will become apparent from the description provided herein. It should be understood that the description and specific examples are intended for purposes of illustration only and are not intended to limit the scope of the present disclosure.

### DRAWINGS

FIG. 1 is a circuit diagram of one form of the present disclosure.

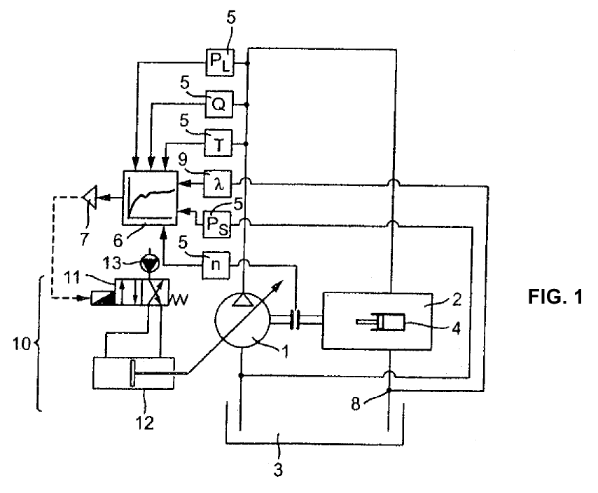

Additional advantages, features, and details of the present disclosure can be seen in the following description, in which, with reference to the drawing, a particularly advantageous forms are described in detail. The features shown in the drawing and mentioned in the description and claims can be employed with the present disclosure, individually or in combination.

### DETAILED DESCRIPTION

The following description is merely exemplary in nature and is not intended to limit the present disclosure, application, or uses.

In order that the disclosure may be well understood, there will now be described various forms thereof, given by way of example, reference being made to the accompanying drawing, in which:

Reference sign 1 refers to a displacement pump, in particular a charger that is driven by an internal combustion engine 2. The displacement pump 1 suctions oil, for example, from an oil sump, and conveys it to a number of lubrication points inside the internal combustion engine 2, only one of which is depicted. The oil runs from the lubrication points back into the oil sump. In the case of a charger, the charger takes in air from the environment 3 and conveys it via the intake tract of the internal combustion engine 2 into the combustion chambers 4. From there, the exhaust gas enters an exhaust gas system 8, and from there it enters the environment 3. In the exhaust gas system 8, there is a lambda probe 9 that supplies characteristic values which are processed in an engine control device, in order to optimize the gas mixture.

The inventive method also uses the characteristic values from measuring points 5 which are present in the engine system, in order to determine supply pressure P_{L}, the delivery volume Q, the temperature T, the suction pressure P_{S}, and the rotational speed n as actual value signals for processing in the control device 6. In the process the existing sensors and adjusted wiring will be used. Furthermore, the existing engine control device will be used and possibly supplemented. In the control device 6, target values for the lambda probe 9 and the measuring points 5 are stored for the respective operational state of the internal combustion engine 2. The actual-value signals determined by the lambda probe 9 and at the measuring points 5 are compared in the control device 6 with the target data stored there. On the basis of the deviations between the actual values and the target values, a control signal is produced in the control device 6, said signal being fed to an actuator 10 via a signal transmitter 7. An enlargement or reduction in the displacement chamber of the displacement pump 1 is effected via the actuator 10 by means of the control signal, until the actual-value signals of the lambda probe 9 and, if required, at the measuring points 5, are identical with the target-value signals in the control device 6. Suitable regulating systems are used for this.

It should be pointed out, that in addition to the lambda probe 9, the measuring points 5 shown in the drawing can be used, and that fewer measuring points 5 or additional measuring points 5 can be used. The control device 6 can be a separate device, or it can be integrated into the engine control unit as mentioned above. In that case, only additional data for the displacement pump 1 and the computation rules for the target-value/actual-value comparison and the signal-control production must be stored. The signal transmitter 7 can also be configured as a separate device or integrated into the control device 6 or into the actuator 10.

The actuator 10 is configured as a discrete component or is integrated into the displacement pump 1. The actuator 10 contains a magnetic valve 11 and a hydraulic drive 12 with pistons that can be driven in both adjustment directions. The hydraulic drive 12 is supplied with a pressure medium via a separate pump 13 or via the lubricant circuit of the internal combustion engine 1.

The drawing described herein is for illustration purposes only and is not intended to limit the scope of the present disclosure in any way.

It should be noted that the disclosure is not limited to the embodiment described and illustrated as examples. A large variety of modifications have been described and more are part of the knowledge of the person skilled in the art. These and further modifications as well as any replacement by technical equivalents may be added to the description and FIGURE, without leaving the scope of the protection of the disclosure and of the present patent.

What is claimed is:

1. A method for adjusting a displacement pump that has a variable volume flow rate in an internal combustion engine with the following procedural steps:
(a) the displacement pump is driven,
(b) a fluid is conveyed to consumption points in the internal combustion engine,
(c) at least one characteristic value is determined from av exhaust gas flow of the internal combustion engine,
(d) said characteristic value is forwarded to a control device as an actual value signal,
(e) the actual value signal is compared to a predetermined target value,
(f) a control signal is preprocessed from the deviation between the actual value signal and the target value,
(g) the control signal is fed to an actuator,
(h) the volume flow rate of the displacement pump is modified by means of the actuator in accordance with the control signal,
(i) steps of (a) through (h) are repeated until the actual value signal is identical to the target value,
whereby an electromotive, hydraulic, or pneumatic drive is used as the actuator, which is acted upon for both directions of adjustment by lubricating oil of the internal combustion engine.

2. The method according to claim 1, characterized in that as characteristic value, a signal is used, in particular one for residual oxygen content, of a lambda probe placed in the exhaust gas flow.

3. The method according to claim 1, characterized in that the target value is supplied in the form of target value ranges.

4. The method according to claim 1, characterized in that the volume flow is only modified when the control signal exceeds a threshold value.

5. The method according to claim 1, characterized in that an existing engine control computer or a separate computer is used as a control device.

6. The method according to claim 1, characterized in that in order to form the control device, the engine control computer is provided with data from the displacement pump and the computation rules for the target value/actual value comparison and for producing the control signal.

7. The method according to claim 1, characterized in that when activating the actuator, the delivery volume of the displacement pump is one of linearly, progressively, or degressively modified.

8. The method according to claim 1, characterized in that in the event of the failure of a control sequence or an individual component, the displacement pump is switched to maximum volume flow.

9. The method according to claim 1, characterized in that an oil pump or gas pump, in particular a charger, is used as a displacement pump.

10. The method according to claim 9, characterized in that a hydrostatic or hydrodynamic charger is used.
